(19) United States
(12) Patent Application Publication
(10) Pub. No.: US 2013/0061969 A1
(43) Pub. Date: Mar. 14, 2013

(54) EXHAUST TRAP

(71) Applicant: Satoru KOIKE, Oshu-shi (JP)

(72) Inventor: Satoru KOIKE, Oshu-shi (JP)

(73) Assignee: TOKYO ELECTRON LIMITED, Tokyo (JP)

(21) Appl. No.: 13/608,695

(22) Filed: Sep. 10, 2012

(30) Foreign Application Priority Data
Sep. 13, 2011 (JP) 2011-199622

(51) Int. Cl. F15D 1/00

(52) U.S. Cl. 138/37

(57) ABSTRACT

An exhaust trap includes an inlet port configured to introduce an exhaust gas discharged from a substrate processing apparatus, an outlet port configured to discharge the exhaust gas introduced from the inlet port, and a plurality of baffle plates arranged therebetween intersecting with a flow direction of the exhaust gas, each of the baffle plates including one or more first holes having a first aperture dimension and a plurality of second holes having a second aperture dimension smaller than the first aperture dimension, wherein the first hole of one of the baffle plates and the first hole of another baffle plate adjacent to said one of the baffle plates are arranged out of alignment with respect to the flow direction of the exhaust gas, and an interval between the two baffle plates adjacent to each other being 0.5 to 2 times as large as the second aperture dimension.

### CROSS-REFERENCE TO RELATED APPLICATION

This application claims the benefit of Japanese Patent Application No. 2011-199622, filed on Sep. 13, 2011, in the Japan Patent Office, the disclosure of which is incorporated herein in its entirety by reference.

### TECHNICAL FIELD

The present disclosure relates generally to manufacturing a semiconductor device, and in particular to an exhaust trap for use in a processing apparatus for subjecting a substrate to gas treatment.

### BACKGROUND

In a manufacturing process of a semiconductor device or a flat panel display (FPD), different processes such as film formation, heat treatment, dry etching and cleaning are performed within a vacuum processing chamber using predetermined gases. A film forming apparatus for performing film formation by, e.g., Chemical Vapor Deposition (CVD), includes a reaction chamber whose inner space is vacuum-evacuatable, a substrate support unit arranged within the reaction chamber and configured to support a substrate such as a semiconductor wafer or the like, a substrate heating unit configured to heat the substrate supported on the substrate support unit, an exhaust device, e.g., a vacuum pump, connected to the reaction chamber through an exhaust pipe and configured to evacuate the reaction chamber and a source supply system configured to supply source gases to the reaction chamber. In this film forming apparatus, the source gases supplied from the source supply system to the reaction chamber are thermally decomposed or chemically reacted in the gas phase or on the substrate by the heat of the substrate being heated by the substrate heating unit. Thus a reaction product is generated and is deposited on the substrate, during the process of forming a thin film on the substrate.

However, the exhaust gas discharged from the reaction chamber contains a reaction product or a byproduct generated but not contributing to the formation of the thin film. It is sometimes the case that, when the exhaust gas flows through an exhaust pipe, the reaction product or the byproduct may aggregate into granular solids that may be deposited on the inner wall of the exhaust pipe or the vacuum pump. Deposition of the reaction product or byproduct material may lead to a reduction of exhaust performance or a malfunction of the vacuum pump.

### SUMMARY

The present disclosure is related to an exhaust trap that increases collection efficiency made compatible with reduced clogging.

According to some embodiments, there is provided an exhaust trap, including: an inlet port configured to introduce an exhaust gas discharged from a processing apparatus for performing processing with respect to a substrate using a processing gas; an outlet port configured to discharge the exhaust gas introduced from the inlet port; and a plurality of baffle plates arranged between the inlet port and the outlet port intersecting with a flow direction of the exhaust gas from the inlet port toward the outlet port, each of the baffle plates including one or more first holes having a first aperture dimension and a plurality of second holes having a second aperture dimension smaller than the first aperture dimension, wherein the first hole of one of the baffle plates and the first hole of another baffle plate adjacent to said one of the baffle plates are arranged out of alignment with respect to the flow direction of the exhaust gas; and an interval between the two baffle plates adjacent to each other being 0.5 to 2 times as large as the second aperture dimension.

### BRIEF DESCRIPTION OF THE DRAWINGS

The accompanying drawings, which are incorporated in and constitute a part of the specification, illustrate embodiments of the present disclosure, and together with the general description given above and the detailed description of various embodiments given below, serve to explain the principles of the present disclosure.

FIG. 1 is a schematic diagram illustrating an exhaust trap and a film forming apparatus to which the exhaust trap is applied, according to some embodiments.

FIG. 2 is a schematic sectional view illustrating the exhaust trap according some embodiments.

FIG. 3 is a schematic top view illustrating a baffle plate arranged within the exhaust trap of FIG. 2, according to some embodiments.

FIG. 4 is a schematic diagram illustrating the relationship between the baffle plates, the rod for positioning the baffle plates and the spacer for adjusting the interval of the baffle plates, according to some embodiments.

FIG. 5 is a top view illustrating the positional relationship between two adjacent baffle plates, according to some embodiments.

FIG. 6 is a top view illustrating the structure of a filter of a filter unit arranged on the exhaust trap of FIG. 2, according to some embodiments.

FIGS. 7A through 7C are illustrative views of the deposit material contained in an exhaust gas being removed by the exhaust trap of FIG. 2, according to some embodiments.

FIGS. 8A and 8B are illustrative views showing an interval size of the exhaust trap of FIG. 2, according to some embodiments.

FIGS. 9A and 9B are illustrative views showing an interval of small-diameter holes of the exhaust trap of FIG. 2, according to some embodiments.

### DETAILED DESCRIPTION

An exhaust trap may be used for collecting deposit material contained in an exhaust gas and preventing the deposit material from flowing downstream.

In some embodiments, an exhaust trap includes a plurality of fin-shaped plates arranged to lengthen a gas flow path. This exhaust trap is configured to collect deposit material contained in an exhaust gas by bringing the exhaust gas into contact with the surface of the plates for a long period of time. In some other embodiments, an exhaust trap includes a plurality of baffle plates having holes, instead of the fin-shaped plates. This exhaust trap is configured to collect deposit material contained in an exhaust gas as a result of repeatedly colliding the exhaust gas against the surfaces of the baffle plates.

In the exhaust trap referred to above, the deposit material contained in the exhaust gas may be collected by depositing the same on the surfaces of the baffle plates or the fin-shaped plates. Therefore, it is sometimes the case that, depending on the arrangement or arrangement interval of the baffle plates or the fin-shaped plates, a large amount of deposit material is deposit on the surfaces of the baffle plates or the fin-shaped plates to clog the flow path. In some instances, it is sometimes difficult to increase the collection efficiency of the deposit material with the configuration of the baffle or fin-shaped plates even if the flow path is not clogged.

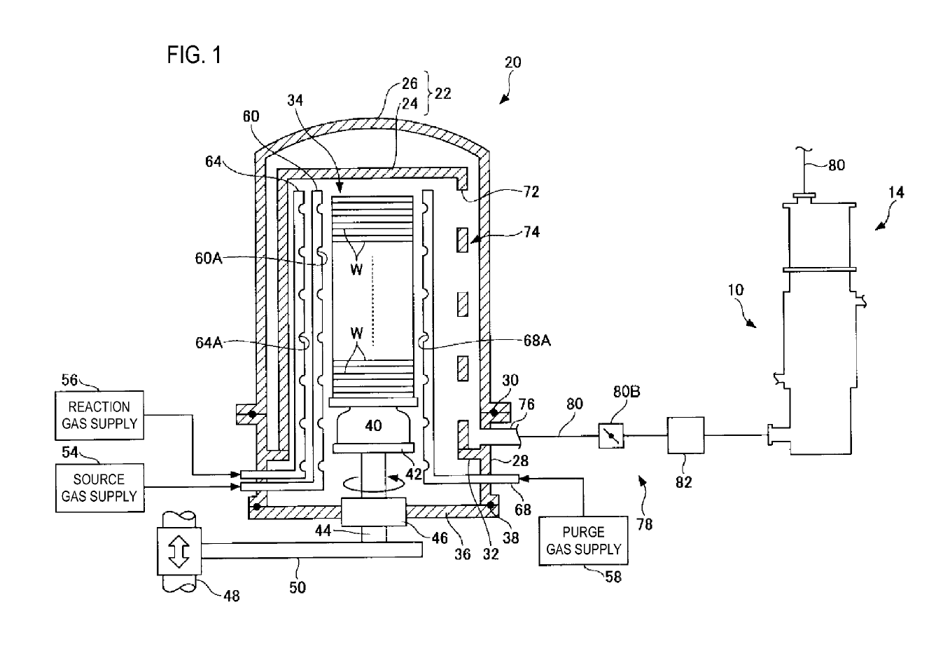

A film forming method and a film forming apparatus (as an example of a processing apparatus) will now be described in detail with reference to the drawings. FIG. 1 is a schematic diagram illustrating an exhaust trap according and a film forming apparatus to which the exhaust trap is applied, according to some embodiments. As shown in FIG. 1, a film forming apparatus 20 includes a processing vessel 22 capable of accommodating a plurality of semiconductor wafers W as objects to be processed. The processing vessel 22 is composed of a vertically-extending inner tube 24 having a closed-top cylindrical shape and a vertically-extending outer tube 26 having a closed-top cylindrical shape. The outer tube 26 is arranged to surround the inner tube 24 with a predetermined clearance between the outer circumference of the inner tube 24 and the inner circumference of the outer tube 26. The inner tube 24 and the outer tube 26 are made of, e.g., quartz.

A manifold 28 having a cylindrical shape and made of, e.g., stainless steel, is air-tightly connected to the lower end portion of the outer tube 26 through a seal member 30 such as an O-ring or the like. The lower end portion of the outer tube 26 is supported by the manifold 28. The manifold 28 is supported by a base plate not shown in the drawings. A ring-shaped support member 32 is provided in the inner wall of the manifold 28. The lower end portion of the inner tube 24 is supported by the support member 32.

A wafer boat 34 as a wafer holder is accommodated within the inner tube 24 of the processing vessel 22. A plurality of wafers W as objects to be processed is held in the wafer boat 34 at a predetermined pitch. For example, 50 to 100 pieces of wafers W having a diameter of 300 mm are held by the wafer boat 34 in multiple stages. The wafer boat 34 can be moved up and down as will be described later. The wafer boat 34 is brought into the inner tube 24 from below the processing vessel 22 through a lower opening of the manifold 28 and is taken out from the inner tube 24 through the lower opening of the manifold 28. The wafer boat 34 may be made of, e.g., quartz.

When the wafer boat 34 is accommodated within the inner tube 24, the lower opening of the manifold 28, i.e., the lower end of the processing vessel 22, is hermetically sealed by a lid 36 formed of, e.g., a quartz plate or a stainless steel plate. In order to maintain air-tightness, a seal member 38, e.g., an O-ring is interposed between the lower end portion of the processing vessel 22 and the lid 36. The wafer boat 34 is placed on a table 42 through a heat insulating barrel 40 made of quartz. The table 42 is supported on the upper end portion of a rotating shaft 44 extending through the lid 36 for opening and closing the lower opening of the manifold 28.

A magnetic fluid seal 46 or the like is provided between the rotating shaft 44 and the hole of the lid 36 through which the rotating shaft 44 extends. Thus the rotating shaft 44 is hermetically sealed and rotatably supported. The rotating shaft 44 is attached to the tip end of an arm 50 supported by a lift mechanism 48, e.g., a boat elevator, so that the wafer boat 34 and the lid 36 can be moved up and down as a unit. Alternatively, the table 42 may be fixedly secured to the lid 36 so that the wafers W can be subjected to film forming treatment without rotating the wafer boat 34. A heating unit (not shown) surrounding the processing vessel 22 and including a heater made of, e.g., a carbon wire, is provided near the side portion of the processing vessel 22. Thus the processing vessel 22 positioned inside the heating unit and the wafers W accommodated therein are heated by the heating unit.

The film forming apparatus 20 includes a source gas supply 54 for supplying a source gas, a reaction gas supply 56 for supplying a reaction gas and a purge gas supply 58 for supplying an inert gas as a purge gas. The source gas supply 54 is configured to hold a silicon-containing gas such as a silane (SiH₄) gas or a dichlorosilane (DCS) gas and is connected to a gas nozzle 60 through a pipe on which a flow rate controller and a shutoff valve (not shown) are installed. The gas nozzle 60 is air-tightly inserted through the manifold 28 and is bent into an L-like shape within the processing vessel 22. The gas nozzle 60 extends over the whole height-direction region within the inner tube 24. A plurality of gas injection holes 60A is formed in the gas nozzle 60 at a predetermined pitch so that the source gas can be supplied in the transverse direction to the wafers W held by the wafer boat 34. The gas nozzle 60 can be made of, e.g., quartz.

The reaction gas supply 56 is configured to hold, e.g., an ammonia (NH₃) gas, and is connected to a gas nozzle 64 through a pipe on which a flow rate controller and a shutoff valve (not shown) are installed. The gas nozzle 64 is air-tightly inserted through the manifold 28 and is bent into an L-like shape within the processing vessel 22. The gas nozzle 64 extends over the whole height-direction region within the inner tube 24. A plurality of gas injection holes 64A is formed in the gas nozzle 64 at a predetermined pitch so that the reaction gas can be supplied in the transverse direction to the wafers W held by the wafer boat 34. The gas nozzle 64 can be made of, e.g., quartz.

The purge gas supply 58 is configured to hold a purge gas and is connected to a gas nozzle 68 through a pipe on which a flow rate controller and a shutoff valve (not shown) are installed. The gas nozzle 68 is air-tightly inserted through the manifold 28 and is bent into an L-like shape within the processing vessel 22. The gas nozzle 68 extends over the whole height-direction region within the inner tube 24. A plurality of gas injection holes 68A is formed in the gas nozzle 68 at a predetermined pitch so that the purge gas can be supplied in the transverse direction to the wafers W held by the wafer boat 34. The gas nozzle 68 can be made of, e.g., quartz. As the purge gas, it is possible to use, e.g., a rare gas such as an Ar gas or a He gas, or an inert gas such as a nitrogen gas.

The gas nozzles 60, 64 and 68 are collectively arranged at one side within the inner tube 24 (In the illustrated example, due to the narrow space, the gas nozzle 68 is shown as if it is arranged at the opposite side from the gas nozzles 60 and 64). In the sidewall of the inner tube 24 opposing to the gas nozzles 60, 64 and 68, a plurality of gas flow holes 72 is formed along the vertical direction. Therefore, the gases supplied from the gas nozzles 60, 64 and 68 flow in the horizontal direction through between the wafers W. Then, the gases are guided into the gap 74 between the inner tube 24 and the outer tube 26 through the gas flow holes 72. An exhaust port 76 communicating with the gap 74 between the inner tube 24 and the outer tube 26 is formed in the upper portion of the manifold 28. An exhaust system 78 for evacuating the processing vessel 22 is connected to the exhaust port 76.

The exhaust system 78 includes a pipe 80 connected to the exhaust port 76. A pressure regulating valve 80B and a vacuum pump 82 are arranged along the pipe 80. The opening degree of a valve body of the pressure regulating valve 80B is adjustable. The pressure regulating valve 80B regulates the internal pressure of the processing vessel 22 by changing the opening degree of the valve body thereof This makes it possible to evacuate the processing vessel 22 to a predetermined pressure while adjusting the pressure of the atmosphere within the processing vessel 22. At the downstream side of the vacuum pump 82, an exhaust trap 10, according to some embodiments, and a filter unit 14 coupled to the upper portion of the exhaust trap 10 are installed in the pipe 80. Thus the processing vessel 22 is evacuated by the vacuum pump 82. The exhaust gas discharged from the vacuum pump 82 flows into the exhaust trap 10. At the downstream side of the filter unit 14, the pipe 80 is connected to an exhaust device (not shown). As a consequence, the exhaust gas whose deposit material is removed in the exhaust trap 10 flows toward the exhaust device. A toxic gas, e.g., a non-decomposed ammonia gas, contained in the exhaust gas is neutralized in the exhaust device and is discharged to the atmosphere.

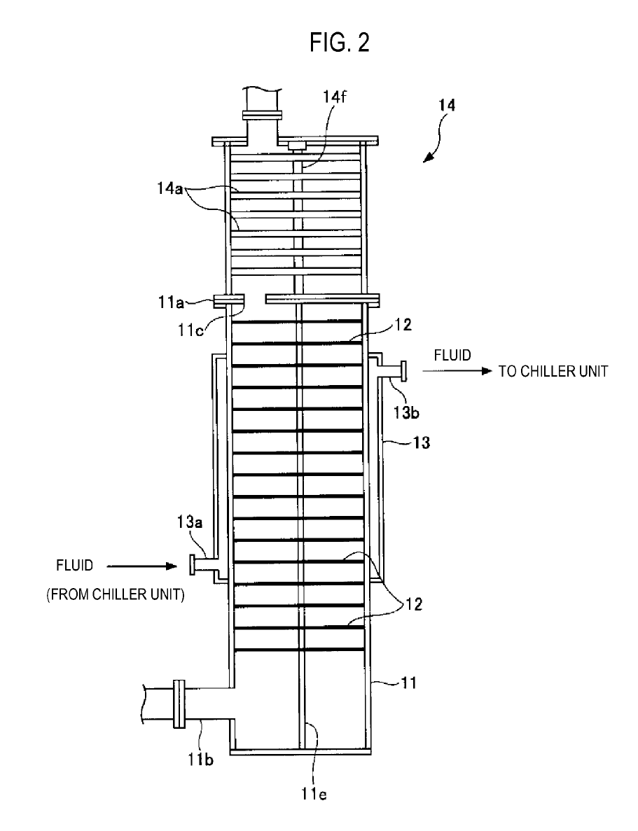

Next, the exhaust trap 10 will be described with reference to FIGS. 2 through 5. As shown in FIG. 2, the exhaust trap 10 includes a cylindrical main body 11 having a top end opening and a sealed bottom portion, a top plate 11a for sealing the top end opening of the main body 11 and a plurality of baffle plates 12 arranged within the main body 11 at a predetermined interval along the height direction. A gas inlet port 11b is formed in the lower region of the side circumference portion of the main body 11. A gas outlet port 11c is formed in the top plate 11a. The top plate 11a is fixed to the top opening edge of the main body 11 through a seal member (not shown) such as an O-ring or a metal seal, whereby the gap between the main body 11 and the top plate 11a is hermetically sealed. Within the main body 11, there is provided a rod 11e extending from the center of the bottom portion of the main body 11 in a substantially perpendicular relationship with the bottom portion. As will be set forth later, the rod 11e has a function of positioning the baffle plates 12.

A cooling jacket 13 is arranged in the side circumference portion of the main body 11 to extend from the middle region to the upper region of the side circumference portion. A fluid inlet port 13a is formed in the lower region of the cooling jacket 13. A fluid outlet port 13b is formed in the upper region of the cooling jacket 13. A fluid whose temperature is adjusted by a chiller unit (not shown) is supplied from the fluid inlet port 13a into the cooling jacket 13. The fluid is circulated so that it can flow out from the fluid outlet port 13b and can come back to the chiller unit. This makes it possible to keep the main body 11 at a predetermined temperature. The exhaust gas discharged from the film forming apparatus 20 is often heated to a high temperature. Thus the main body 11 and the baffle plates 12 are also heated. In that case, the attachment coefficient of the deposit material is decreased. However, the main body 11 is kept at a predetermined temperature by the chiller unit. This makes it possible to prevent the baffle plates 12 from being heated and to increase the attachment coefficient. In other words, the collection amount of the deposit material can be increased by installing the cooling jacket 13 and adjusting the temperature of the main body 11 with the chiller unit.

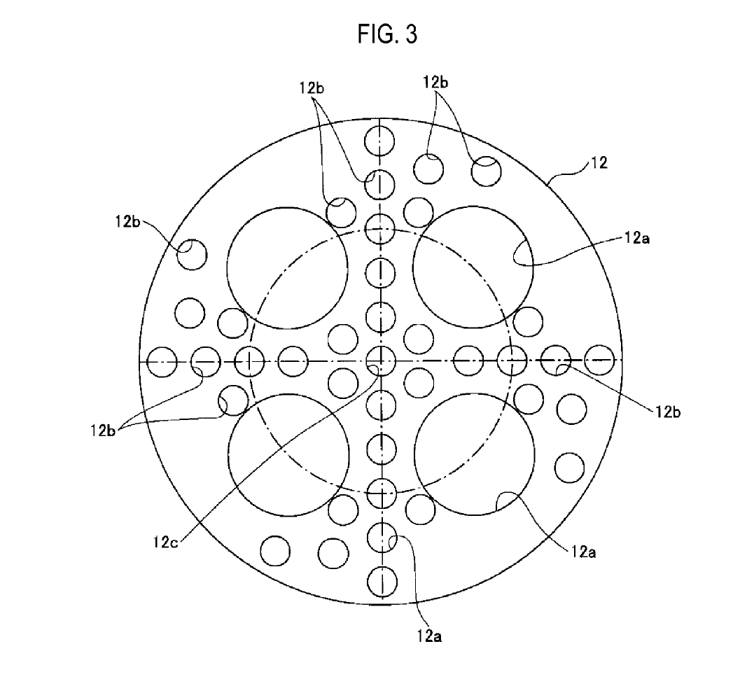

Referring to FIG. 3, the baffle plate 12 has a disc-like top surface shape and is made of metal, e.g., stainless steel. The thickness of the baffle plate 12 may be set such that, when the deposit material adheres to the baffle plate 12, the baffle plate 12 can withstand the weight of the deposit material. The thickness of the baffle plate 12 may be, e.g., from 0.5 mm to 5.0 mm. For example, the thickness of the baffle plate 12 may be set equal to about 1 mm. The outer diameter of the baffle plate 12 may be set as close to the inner diameter of the main body 11 as possible, as long as the baffle plate 12 can be arranged within the main body 11. In some embodiments, the outer diameter of the baffle plate 12 may be set equal to about 200 mm. The baffle plate 12 has four large-diameter holes 12a (first holes), a plurality of (thirty eight, in the illustrated example) small-diameter holes 12b (second holes) and a centrally-positioned guide hole 12c. The centers of the large-diameter holes 12a lie on the circumference of a circle which is concentric with the outer circumferential circle of the baffle plate 12. The large-diameter holes 12a are spaced apart from one another at an angular interval of about 90 degrees. The inner diameter of the large-diameter holes 12a may be set such that four large-diameter holes 12a can be formed in the baffle plate 12. The inner diameter of the large-diameter holes 12a may be, e.g., from 42 mm to 76 mm. In some embodiments, the inner diameter of the large-diameter holes 12a may be set equal to about 50 mm. The small-diameter holes 12b are regularly or randomly arranged in the region of the baffle plate 12 other than the large-diameter holes 12a. In the illustrated example, six small-diameter holes 12b are arranged around the guide hole 12c at an angular interval of 60 degrees. Four small-diameter holes 12b are formed between two adjacent large-diameter holes 12a and are arranged along the radial direction of the baffle plate 12 at a substantially equal interval. The inner diameter of the small-diameter holes 12b is smaller than the inner diameter of the large-diameter holes 12a and may be, e.g., from 10 mm to 20 mm. Other configurations are, however, possible. In some embodiment, the inner diameter of the small-diameter holes 12b may be set equal to about 12 mm.

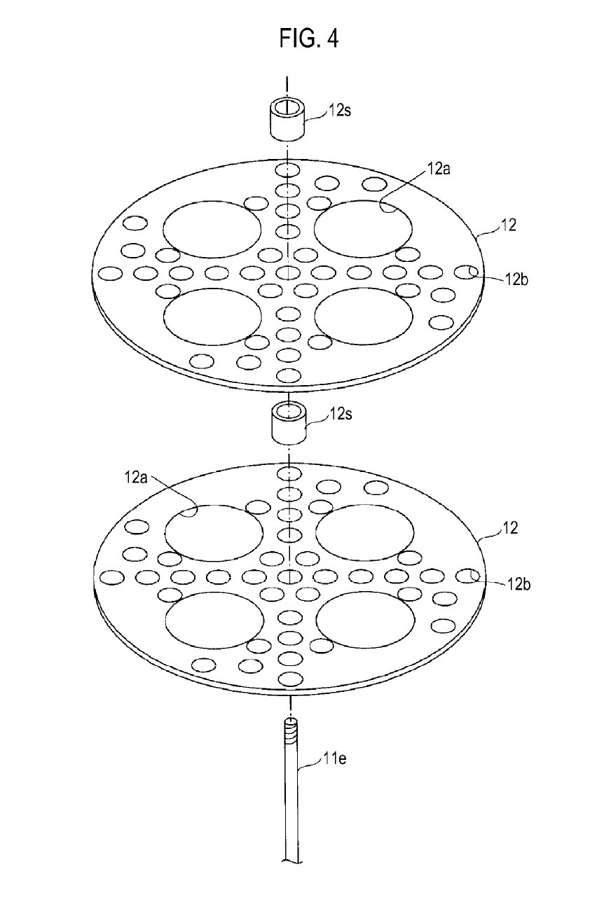

The guide hole 12c has an inner diameter a little larger than the outer diameter of the rod 11e. The position of the baffle plate 12 is fixed as the rod 11e is inserted through the guide hole 12c. More specifically, as shown in FIG. 4, if the baffle plates 12 and the cylindrical spacers 12s at which the rod 11e is inserted are alternately fitted to the rod 11e along the vertical direction, the positions of the baffle plates 12 are fixed in the vertical direction and the horizontal direction. The interval of the baffle plates 12 can be appropriately adjusted depending on the height of the spacers 12s. In some embodiments, the interval of the baffle plates 12 may be set equal to about 10 mm. In other words, the baffle plates 12 are arranged at a pitch of about 11 mm (the thickness of the baffle plates 12 of 1 mm plus the interval of the baffle plates 12 of 10 mm).

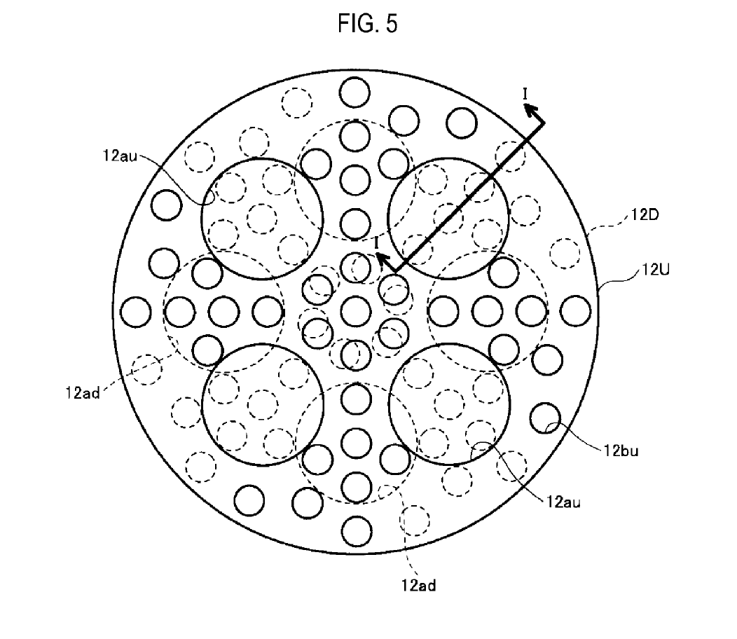

FIG. 5 is a top view schematically illustrating two arbitrary baffle plates 12 adjacent to each other in the vertical direction, among the baffle plates 12 arranged within the main body 11 of the exhaust trap 10, according to some embodiments. In FIG. 5, the upper baffle plate 12U is indicated by solid lines and the lower baffle plate 12D is indicated by broken lines. As shown in FIG. 5, the large-diameter holes 12au of the upper baffle plate 12U are out of alignment with the large-diameter holes 12ad of the lower baffle plate 12D at an angle of about 45 degrees. With this arrangement, the exhaust gas passing through the large-diameter holes 12ad of the lower baffle plate 12D mainly flows through the small-diameter holes 12bu of the upper baffle plate 12U. In other words, the exhaust gas does not flow through only the large-diameter holes 12a but does flow through the small-diameter holes 12b at least once.

As will be described later, the small-diameter holes 12b have a function of collecting the deposit material contained in the exhaust gas flowing through the exhaust trap 10. Just like the small-diameter holes 12b, the large-diameter holes 12a have a function of collecting the deposit material. The large-diameter holes 12a further have a function of providing an exhaust gas flow path in the event that the small-diameter holes 12b are clogged.

Referring again to FIG. 2, the filter unit 14 is air-tightly arranged on the top plate 11a of the main body 11. The internal space of the exhaust trap 10 communicates with the internal space of the filter unit 14 through the gas outlet port 11c of the top plate 11a. Within the filter unit 14, a plurality of mesh plates 14a is arranged at a predetermined interval along the vertical direction. The inner diameter of the filter unit 14 is substantially equal to the inner diameter of the main body 11 of the exhaust trap 10. Likewise, the outer diameter of the mesh plates 14a is substantially equal to the outer diameter of the baffle plates 12.

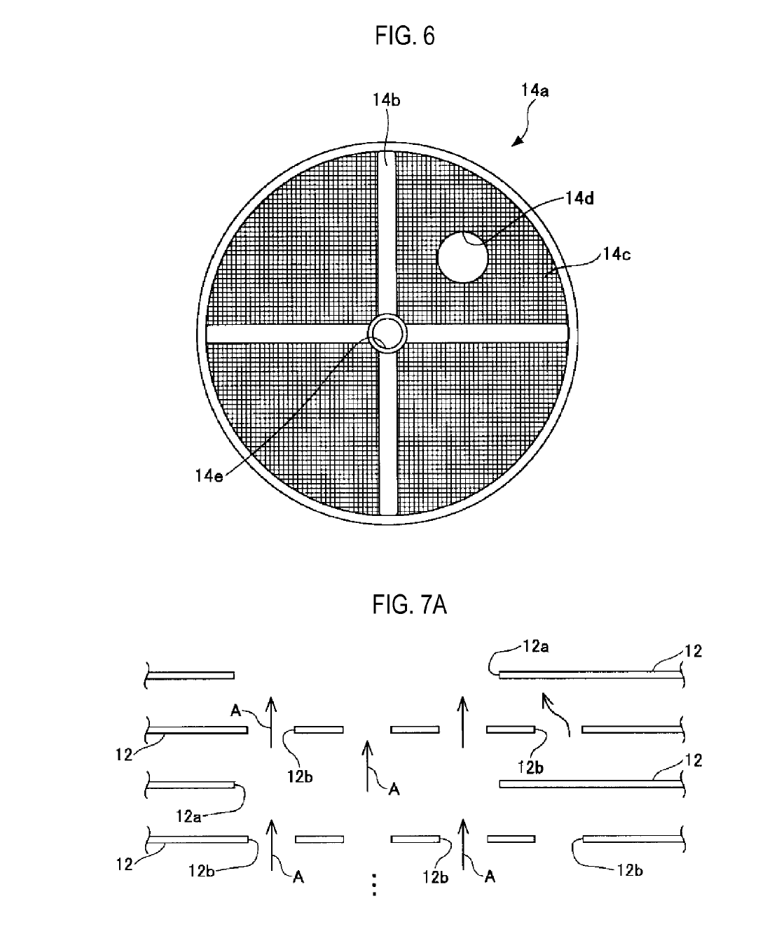

Referring to FIG. 6, the mesh plates 14a have a disc-like top surface shape. Each of the mesh plates 14a includes a cross-shaped support member 14b, a mesh portion 14c supported by the support member 14b, an opening 14d formed in the mesh portion 14c and a guide hole 14e formed at the center. The mesh portion 14c is made of, e.g., stainless steel. The mesh portion 14c may have an aperture size (opening dimension) smaller than the inner diameter of the small-diameter holes 12b of the baffle plates 12. The aperture size may be, e.g., from 5 mm to 10 mm. The mesh plates 14a collect the fine particles of deposit material remaining in the exhaust gas coming from the exhaust trap 10 or the reaction byproduct contained in the exhaust gas. The opening 14d is formed in order to enable the exhaust gas to flow even when the mesh portion 14c is clogged. The guide hole 14e is formed so that the positions of the mesh plates 14a can be fixed by inserting the guide rod 14f (see FIG. 2) into the guide hole 14e.

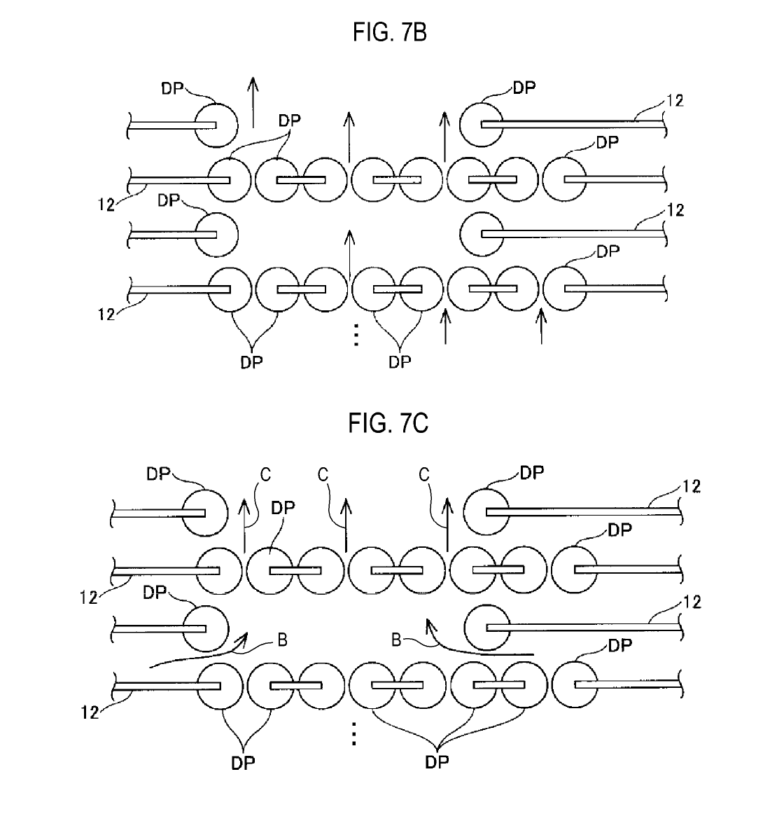

Referring to FIGS. 1, 7A-7C through 9A-9B, description will be made on how the deposit material contained in the exhaust gas is collected by the exhaust trap 10 according to some embodiments. FIGS. 7A, 7B and 7C are sectional views taken along line I-I in FIG. 5, illustrating four baffle plates 12 arranged one above another. The exhaust gas discharged from the film forming apparatus 20 (see FIG. 1) and flowing from the gas inlet port 11b into the main body 11 flows upward within the main body 11 (see arrows A), during which time the flow direction of the exhaust gas is slightly changed by the baffle surfaces of the baffle plates 12 (the areas other than the holes 12a and 12b). Within the main body 11, the exhaust gas predominantly flows toward the baffle plates 12 through the large-diameter holes 12a and the small-diameter holes 12b rather than along the surfaces of the baffle plates 12. When the exhaust gas flows through the large-diameter holes 12a and the small-diameter holes 12b, the deposit material contained in the exhaust gas is adsorbed to the inner periphery (edges) of the large-diameter holes 12a and the small-diameter holes 12b. The deposit material adsorbed to the edges becomes nuclei. The deposit material contained in the exhaust gas is further adsorbed to the nuclei. The deposit material grows on the nuclei. As a result, as shown in FIG. 7B, deposits DP having a substantially circular cross section are formed around the edges of the large-diameter holes 12a and the small-diameter holes 12b (The deposits DP have an annular shape because the deposits DP grow along the circular edges of the large-diameter holes 12a and the small-diameter holes 12b). In this manner, it is possible to efficiently collect the deposit material from the exhaust gas.

If the deposits DP continue to grow, as shown in FIG. 7C, there occurs a situation that, in the lowermost baffle plate 12, the small-diameter holes 12b are clogged by the deposits DP grown from the edge. Even in that case, however, the large-diameter holes 12a (not shown) of the baffle plates 12 are not clogged. Thus the exhaust gas flows through the large-diameter holes 12a toward a baffle plate 12 one above (see arrows B). Then, the exhaust gas passes through the small-diameter holes 12b of the baffle plate 12 one above (see arrows C). At this time, as described above, the deposit material remaining in the exhaust gas is deposited on the edges of the small-diameter holes 12b and continues to grow. Therefore, the deposit material is efficiently collected from the exhaust gas.

If the deposit material is further collected in the state shown in FIG. 7C, the deposit adhering to the edge of the large-diameter hole 12a of the second baffle plate 12 from the bottom makes contact with the deposits adhering to the edges of the small-diameter holes 12b of the lowermost baffle plate 12. If so, the large-diameter hole 12a of the second baffle plate 12 from the bottom may be surrounded and clogged by the deposits. Even in that case, however, the exhaust gas can pass through the large-diameter hole 12a of the second baffle plate 12. FIG. 7C as a sectional view taken along line I-I in FIG. 5 shows that the small-diameter holes 12b (12bu) of the lower baffle plate 12 (12D) are positioned below the large-diameter holes 12a (12au) of the upper baffle plate 12 (12U). However, in the cross section deviated from line I-I, the small-diameter holes 12b (12bu) do not exist below the edges of the large-diameter holes 12a (12au). Therefore, a gap exists between the deposits adhering to the edges of the large-diameter holes 12a (12au) of the upper baffle plate 12 (12U) and the lower baffle plate 12 (12D). The exhaust gas can flow upward through the gap and the large-diameter holes 12a (12au) of the upper baffle plate 12 (12U).

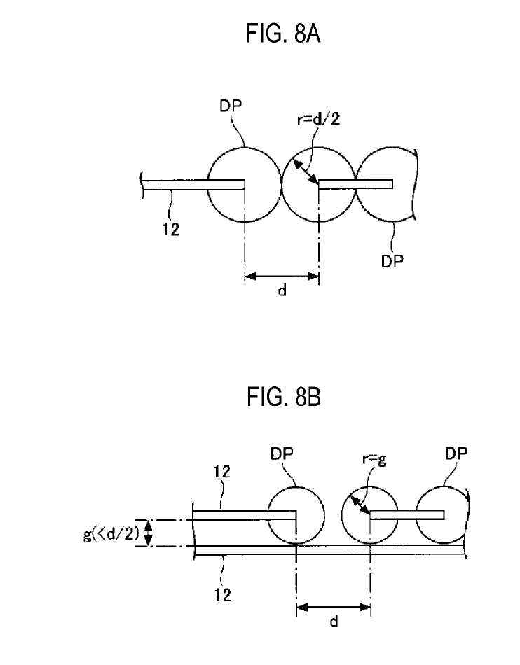

As can be noted from FIG. 8A, when the small-diameter holes 12b are clogged, the radius r of the circular cross section of the deposits DP is substantially equal to about one half of the inner diameter d of the small-diameter holes 12b. In other words, the deposit material can be collected by the edges of the small-diameter holes 12b until the radius r of the deposits DP adhering to the edges of the small-diameter holes 12b becomes equal to about one half of the inner diameter d of the small-diameter holes 12b. In this regard, if the gap g between the baffle plates 12 is smaller than one half of the inner diameter d of the small-diameter holes 12b and if the small-diameter holes 12b of one of the baffle plates 12 are opposed to the baffle surface of the adjacent baffle plate 12 as shown in FIG. 8B, the deposits DP adhering to the edges of the small-diameter holes 12b make contact with the baffle surface of the adjacent baffle plate 12 before the small-diameter holes 12b get clogged, thereby hindering the flow of the exhaust gas. In that case, the deposits DP do not grow any more. In other words, the small-diameter holes 12b are unable to collect the deposit material contained in the exhaust gas even though they can collect the deposit material. In order to avoid such a situation, the gap g between the baffle plates 12 may be set larger than about one half of the inner diameter d of the small-diameter holes 12b.

From the viewpoint of collection amount, an increased number of baffle plates 12 may be arranged within the main body 11 of the exhaust trap 10. For that reason, it is not advisable to excessively increase the gap g between the baffle plates 12. For example, when the small-diameter holes 12b are clogged, the conductance becomes smaller around the small-diameter holes 12b. It is therefore likely that the flow velocity of the exhaust gas and the collection efficiency get decreased. If the gap g between the baffle plates 12 is set approximately twice as large as the inner diameter d of the small-diameter holes 12b, the positions of the small-diameter holes 12b of two vertically-adjacent baffle plates 12 are aligned with each other in the vertical direction. Therefore, even when the small-diameter holes 12b are clogged by the deposits, a wide enough gap is left between the two baffle plates 12 in the vertical direction. It is therefore possible to avoid reduction of conductance in the area around the clogged small-diameter holes 12b. As a result, it is possible to avoid reduction of the collection efficiency.

As stated above, the radius of the deposits clogging the small-diameter holes 12b is equal to one half of the inner diameter d of the small-diameter holes 12b. Accordingly, if the gap between two vertically-adjacent baffle plates 12 is set approximately twice as large as the inner diameter d of the small-diameter holes 12b, the gap left between the two vertically-adjacent baffle plates 12 (the gap between the deposits) is substantially equal to the inner diameter d of the small-diameter holes 12b when the small-diameter holes 12b are clogged.

Alternatively, the gap g between the baffle plates 12 may be set equal to the inner diameter d of the small-diameter holes 12b. In that case, even if the positions of the small-diameter holes 12b of the two vertically adjacent baffle plates 12 are aligned with each other in the vertical direction, a gap is left between the two baffle plates 12 until the small-diameter holes 12b are clogged. It is therefore possible to secure gas flow paths extending through the small-diameter holes 12b.

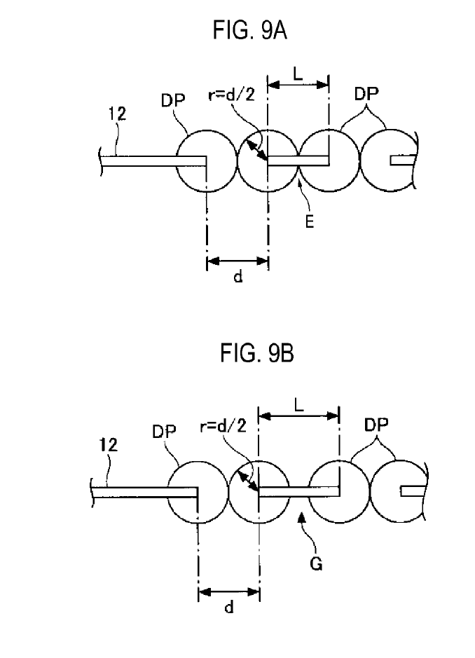

Referring to FIG. 9A, the small-diameter holes 12b may be formed such that, when the small-diameter holes 12b are clogged, the deposit DP adhering to the edge of one of the small-diameter holes 12b makes contact with the deposit DP adhering to the edge of the adjacent small-diameter hole 12b (see an arrow E in FIG. 9A). In other words, the interval L between the small-diameter holes 12b may be adjusted such that, when the small-diameter holes 12b are clogged, a gap G is not created between the deposits DP adhering to the edges of two adjacent small-diameter holes 12b. More specifically, since the radius r of the deposits DP when the small-diameter holes 12b are clogged is equal to about one half of the inner diameter d of the small-diameter holes 12b, the interval L between two adjacent small-diameter holes 12b in one of the baffle plates 12 may be equal to or smaller than the inner diameter d of the small-diameter holes 12b. This makes it possible to reduce the interval L between the small-diameter holes 12b and to form the small-diameter holes 12b at a high density. Accordingly, it is possible to increase the collection amount of the deposit material.

With a view to generate nuclei in the edges of the large-diameter holes 12a and the small-diameter holes 12b and to form deposits having a circular cross-sectional shape about the nuclei, the thickness of the baffle plates 12 may be set as small as possible insofar as the baffle plates 12 have a strength capable of withstanding the weight of the deposits. As mentioned above, the thickness of the baffle plates 12 may be, e.g., from 0.5 mm to 5 mm.

Next, description will be made on the collection amount of the deposit material in the film forming apparatus 20 calculated using the exhaust trap 10. In the exhaust trap 10 used, the number of the baffle plates 12 is nineteen, the interval between the baffle plates 12 is 10 mm, the number of the large-diameter holes 12a is four, the inner diameter of the large-diameter holes 12a is 50 mm, the number of the small-diameter holes 12b is thirty eight, and the inner diameter of the small-diameter holes 12b is 12 mm. The film forming apparatus 20 was operated 42 days and the collection amount of silicon nitride was found (Example). A DCS gas was used as a silicon-containing gas. Ammonia gas was used as a nitriding gas.

For the sake of comparison, an exhaust trap according to a comparative example was prepared. This exhaust trap differs from the exhaust trap 10 in that the exhaust trap is provided with baffle plates differing from the baffle plates 12. Other configurations of the exhaust trap according to the comparative example remain the same as those of the exhaust trap 10. Seventeen baffle plates having four holes equal in inner diameter to one another and two baffle plates 12 are accommodated within the exhaust trap. The seventeen baffle plates include three baffle plates having holes of 50 mm in inner diameter, five baffle plates having holes of 40 mm in inner diameter and nine baffle plates having holes of 20 mm in inner diameter. In addition, the two baffle plates 12, the three baffle plates having holes of 50 mm in inner diameter, the five baffle plates having holes of 40 mm in inner diameter and the nine baffle plates having holes of 20 mm in inner diameter are arranged in the named order from the gas inlet port 11b to the gas outlet port 11c. The interval of the baffle plates is gradually reduced from the gas inlet port 11b toward the gas outlet port 11c. The interval of the baffle plates 12 arranged near the gas inlet port 11b is 50 mm. The exhaust trap configured as above was connected to the film forming apparatus 20. The film forming apparatus 20 was operated under the same conditions.

The collection amount of the deposit material was found based on the difference in the weight of the exhaust trap before and after the tests. The tests reveal that about 5,920 g of silicon nitride was collected in the example while 2,430 g of silicon nitride was collected in the comparative example. As a result of visual inspection, the intermediate baffle plates were clogged in the exhaust trap of the comparative example. In case of the exhaust trap 10 of the example, most of the small-diameter holes 12b of the baffle plate 12 nearest to the gas inlet port 11b (the lowermost baffle plate 12) were clogged but at least the central areas of the large-diameter holes 12a of the lowermost baffle plate 12 were kept open. This means that the exhaust trap 10 of the example can be continuously used. As can be noted from the above test results, the exhaust trap 10 of the example is capable of efficiently collecting the deposit material and can be used for a prolonged period of time with no clogging.

As described above, with the exhaust trap 10, the baffle plates 12 having the large-diameter holes 12a and the small-diameter holes 12b are arranged across the stream of the exhaust gas. The deposit material contained in the exhaust gas is positively deposited on the edges of the large-diameter holes 12a and the small-diameter holes 12b of the baffle plates 12. Therefore, the exhaust trap 10 can collect the deposit material in an efficient manner. In the conventional exhaust traps, the deposit material is deposited on the surfaces of fin-shaped plates or baffle plates. If the edges of the large-diameter holes 12a and the small-diameter holes 12b are used in place of the surfaces, nuclei are formed with ease and deposits DP grow about the nuclei. It is therefore apparent that the collection efficiency gets improved. It goes without saying that the deposit material can be deposited on the baffle surfaces of the baffle plates 12.

Even when the small-diameter holes 12b are clogged, the large-diameter holes 12a are not clogged. Therefore, the exhaust gas can pass through the large-diameter holes 12a of the baffle plates 12, whereby the deposit material is collected by other baffle plates 12 arranged at the downstream side of the upstream baffle plates 12. In other words, even if the small-diameter holes 12b of one of the baffle plates 12 are clogged, the exhaust gas can flow the large-diameter holes 12a. This makes it possible to continuously use the exhaust trap 10 and to collect the deposit material with the baffle plates 12 arranged at the downstream side.

In the conventional exhaust trap employing fin-shaped plates, in an effort to avoid clogging, the interval of the fin-shaped plates is increased near the inlet port where the concentration of the deposit material in the exhaust gas is high, and the interval of the fin-shaped plates is reduced near the outlet port where the concentration of the deposit material in the exhaust gas is low. In case where the interval of the baffle plates is set differently, it is necessary to determine the interval by conducting tests according to the kinds of gases used and the use conditions.

In the exhaust trap 10 according to some embodiments, even when the small-diameter holes 12b are clogged, the exhaust gas can pass through the large-diameter holes 12a. It is therefore not necessary that the interval of the baffle plates 12 arranged near the gas inlet port 11b be increased in order to secure an exhaust gas flow path. As set forth above, the interval of the baffle plates 12 can be determined depending on the inner diameter of the small-diameter holes 12b and can be kept constant in the vertical direction. Accordingly, it is possible to densely arrange the baffle plates 12, thereby enhancing the collection efficiency.

While the present disclosure has been described above with reference to certain embodiments, the present disclosure is not limited to the embodiments described above but may be modified, combined or changed in many different forms without departing from the scope of the appended claims. For example, while four large-diameter holes 12a are formed in the exhaust trap 10 of the embodiments described above, the number of the large-diameter holes 12a may be one, two, four or more. In an instance where three large-diameter holes 12a are formed, the two vertically-adjacent baffle plates 12 may be out of alignment with each other by an angle of 60 degrees. This eliminates the possibility that the large-diameter holes 12a of the two baffle plates 12 vertically overlap with each other.

In the embodiment described above, the exhaust trap 10 is arranged at the downstream side of the vacuum pump 82 for evacuating the processing vessel 22 of the film forming apparatus 20. Alternatively, the exhaust trap 10 may be arranged between the processing vessel 22 and the vacuum pump 82. In that case, the exhaust trap 10 may be arranged between the pressure regulating valve 80B and the vacuum pump 82.

While the filter unit 14 is arranged above the exhaust trap 10 in the embodiment described above, it may be possible to omit the filter unit 14. The gas outlet port 11c of the exhaust trap 10 may not be formed in the top plate 11a but may be formed in the upper area of the side circumferential portion of the main body 11.

In the embodiment described above, the spacers 12s having a cylindrical shape and surrounding the rod 11e are used to decide the interval of the baffle plates 12. In another embodiment, it may be possible to use ring-shaped spacers having an outer diameter equal to the outer diameter of the baffle plates 12 and having a thickness (width) large enough to support the baffle plates 12.

The plan-view shape of the large-diameter holes 12a and the small-diameter holes 12b is not limited to the circular shape but may be a polygonal shape. If the small-diameter holes 12b have a polygonal shape, it is apparent that the dimension and interval of the small-diameter holes 12b and the interval of the baffle plates 12 should be decided depending on the distance from the edge of the polygonal hole to the center thereof The edges of the large-diameter holes 12a and the small-diameter holes 12b may be formed roughly and not smoothly or may be formed into a serrated shape. This makes it possible to accelerate formation of nuclei.

In the embodiment described above, the exhaust trap 10 is applied to the film forming apparatus 20 for forming a silicon nitride film using a silane gas or a DCS gas as a source gas and using an ammonia gas as a nitriding gas. Alternatively, the exhaust trap 10 may be applied not only to the film forming apparatus for forming a silicon nitride film but also to a film forming apparatus for forming a thin film such as a silicon oxide film, a silicon oxynitride film, an amorphous silicon film, an amorphous carbon film or a polyimide film. Needless to say, the exhaust trap 10 may be applied not only to the film forming apparatus but also to an etching apparatus or a cleaning apparatus using a gas.

With the embodiment of the present disclosure, there is provided an exhaust trap in which the increased collection efficiency and the reduced clogging are compatible.

While certain embodiments have been described, these embodiments have been presented by way of example only, and are not intended to limit the scope of the disclosures. Indeed, the novel exhaust trap described herein may be embodied in a variety of other forms; furthermore, various omissions, substitutions, combinations and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An exhaust trap, comprising:
an inlet port configured to introduce an exhaust gas discharged from a processing apparatus to process a substrate with a processing gas;
an outlet port configured to discharge the exhaust gas introduced from the inlet port; and
a plurality of baffle plates arranged between the inlet port and the outlet port intersecting with a flow direction of the exhaust gas from the inlet port toward the outlet port, each of the baffle plates including one or more first holes having a first aperture dimension and a plurality of second holes having a second aperture dimension smaller than the first aperture dimension,
wherein the first hole of one of the baffle plates and the first hole of another baffle plate adjacent to said one of the baffle plates are arranged out of alignment with respect to the flow direction of the exhaust gas; and
an interval between the two baffle plates adjacent to each other being 0.5 to 2 times as large as the second aperture dimension.

2. The exhaust trap of claim 1, wherein the second holes of each of the baffle plates are arranged at an interval equal to or smaller than the second aperture dimension.

3. The exhaust trap of claim 1, further comprising:
an adjusting member configured to adjust the interval of the baffle plates.

4. The exhaust trap of claim 1, further comprising:
a filter unit communicating with the outlet port, the filter unit including mesh plates arranged spaced-apart from each other, each of the mesh plates provided with a mesh portion having a predetermined aperture size.

5. The exhaust trap of claim 1, wherein the interval between the two baffle plates adjacent to each other being 0.5 to 1 times as large as the second aperture dimension.
